(19) United States
(12) Patent Application Publication
(10) Pub. No.: US 2007/0011646 A1
(43) Pub. Date: Jan. 11, 2007

(54) Parallel Decoupled Mesh Generation

(75) Inventors: Nikos P. Chrisochoides, Williamsburg, VA (US); Leonidas Linardakis, Williamsburg, VA (US)

Correspondence Address: WILLIAM AND MARY TECHNOLOGY TRANSFER OFFICE, 402 JAMESTOWN RD, PO BO 8795, WILLIAMSBURG, VA, 23187-8795, US

(73) Assignee: College of William and Mary

(21) Appl. No.: 11/426,478

(22) Filed: Jun. 26, 2006

Related U.S. Application Data
(60) Provisional application No. 60/694,116, filed on Jun. 24, 2005.

(51) Int. Cl. G06F 17/50

(52) U.S. Cl. 716/20

(57) ABSTRACT

A method of mesh generation processing for a bounded domain is provided. The bounded domain is divided into constituent sub-domains with a portion of the sub-domains being assigned to each of a plurality of processors. The processors are operated independently and in parallel. Each processor (i) discretizes the closed boundary for each of its sub-domains to generate coordinates that are identical for each portion of adjoining sub-domain boundaries and that satisfy specific conditions that optimize a selected mesh generation technique, and (ii) generates a mesh for each sub-domain assigned thereto using corresponding ones of the coordinates and the selected mesh generation technique.

### CROSS-REFERENCE TO RELATED APPLICATIONS

Pursuant to 35 U.S.C. §119, the benefit of priority from provisional application 60/694,116, with a filing date of Jun. 24, 2005, is claimed for this non-provisional application.

### STATEMENT REGARDING FEDERALLY SPONSORED RESEARCH OR DEVELOPMENT

This invention was made with Government support under Grant Nos. 0049086, 0085969 and 0203974 awarded by the National Science Foundation (NSF). The Government has certain rights in this invention.

### FIELD OF THE INVENTION

The invention relates generally to mesh generation processing, and more particularly to a method of mesh generation processing that is carried out using parallel processing techniques without the need for communication and synchronization between the processors.

### BACKGROUND OF THE INVENTION

As is known in the art, mesh generation of a two or three-dimensional domain involves the generation of nodes and a triangulation process using the nodes to create a mesh that describes the domain. High-quality sequential mesh generators exist to perform such mesh generation. However, these mesh generators are designed to operate on a single processor and, therefore, can require a great deal of time to complete a given mesh generation task. Accordingly, it is preferred to perform mesh generation using parallel processing techniques. However, while parallel mesh generation procedures decompose the mesh generation problem into smaller subproblems that can be solved in parallel, the parallel methods generally require the time-consuming tasks of communication and synchronization (between processors) during the meshing of the subproblems. Further, software-based high-quality sequential mesh generators frequently have to be modified for operation in a parallel mesh generation operation. Unfortunately, software code modifications generally affect the quality of the ultimately-generated mesh. In addition, as new versions of existing mesh generators are made available, the new versions must be reviewed and modified in order to be run in a parallel processing environment. Such review and modification is time-consuming and expensive.

### SUMMARY OF THE INVENTION

Accordingly, it is an object of the present invention to provide a method of mesh generation using parallel processing techniques.

Another object of the present invention is to provide a parallel processing method of mesh generation that eliminates the need for communication and synchronization between the processors being used.

Still another object of the present invention is to provide a parallel processing method of mesh generation that produces a mesh commensurate in quality with those produced by sequential mesh generation techniques.

Yet another object of the present invention is to provide a parallel processing method of mesh generation that can utilize existing high-quality sequential mesh generation software without any modification thereof.

Other objects and advantages of the present invention will become more obvious hereinafter in the specification and drawings.

In accordance with the present invention, a method of mesh generation processing for a bounded domain is provided. The bounded domain is divided into constituent sub-domains with each of sub-domain being defined by a closed boundary. A number of the sub-domains are assigned to each of a plurality of processors. The processors are operated independently and in parallel. More specifically, each processor (i) discretizes the closed boundary for each sub-domain assigned thereto to generate coordinates that discretely define the closed boundary where the coordinates are identical for each portion of one closed boundary that adjoins (i.e., forms) a portion of another closed boundary, and where all of the coordinates satisfy specific conditions that optimize a selected mesh generation technique, and (ii) generates a mesh for each sub-domain assigned thereto using corresponding ones of the coordinates and the selected mesh generation technique.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of a bounded domain;

FIG. 2 is a schematic view of the bounded domain divided into sub-domains and assigned to processors that operate independently and in parallel to achieve mesh generation in accordance with the present invention;

FIG. 3 is a schematic view illustrating the results of discretization of sub-domain boundaries;

FIG. 4 is a schematic view of the sub-domains illustrating the mesh generation process;

FIG. 5 illustrates the medial axis for a rectangle;

FIG. 6 illustrates the medial axis for a bounded domain that is essentially a rectangle whose peripheral boundary is slightly disturbed;

FIG. 7 illustrates an approximated medial axis generated from the circumcenters of boundary-conforming Delaunay triangles in accordance with the present invention; and

FIGS. 8A-8C are graphic depictions of a portion of a bounded domain that illustrate the concept of junction triangles used in the medial axis domain decomposition method of the present invention.

### DETAILED DESCRIPTION OF THE INVENTION

Prior to describing the parallel decoupled mesh generation of the present invention, it will be helpful to explain the terms “parallel” and “decoupled” as used herein. The term parallel refers to parallel processing techniques that include those that work using physically separate processors, both shared and distributed memory processors, current and emerging multi-core processors, multi-processor (super-)computers, and clusters of (super-)computers connected via any kind of interconnection network. The term decoupled means that the mesh generation is carried out for constituent sub-domains of a larger bounded domain using parallel processing techniques without requiring any communication or synchronization between the “processors” being used.

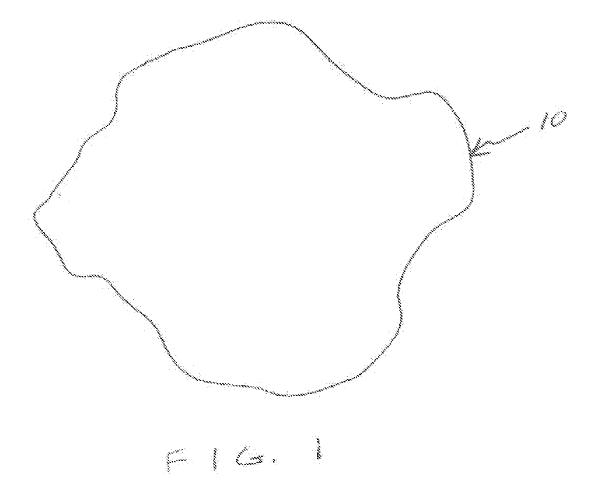

Parallel decoupled mesh generation of the present invention will first be described for the general case using FIGS. 1-4. Then, by way of illustrative example, the process will be described in greater detail for the meshing of a two-dimensional bounded domain. This example will achieve/guarantee parallel decoupled mesh generation using the well-known Delaunay triangulated mesh generation technique without any modification thereof. This example, as well as the proofs of its efficacy, are described by L. Linardakis and N. Chrisochoides in “Parallel Domain Decoupled Delaunay Method,” SIAM Journal on Scientific Computing, Volume 27, Issue 4, pp. 1394-1423, 2006, the contents of which are hereby incorporated by reference.

Referring now to FIG. 1, a bounded domain 10 is representative of any two or three-dimensional object for which a mesh is to be generated. While the concepts presented in the following description of the general case can be applied to mesh a two or three-dimensional object, a two-dimensional object is shown for ease of illustration. The type of object defined by bounded domain 10 is not a limitation of the present invention. For example, an object's bounded domain could also contain holes as would be the case if the bounded domain were the cross-section of a pipe.

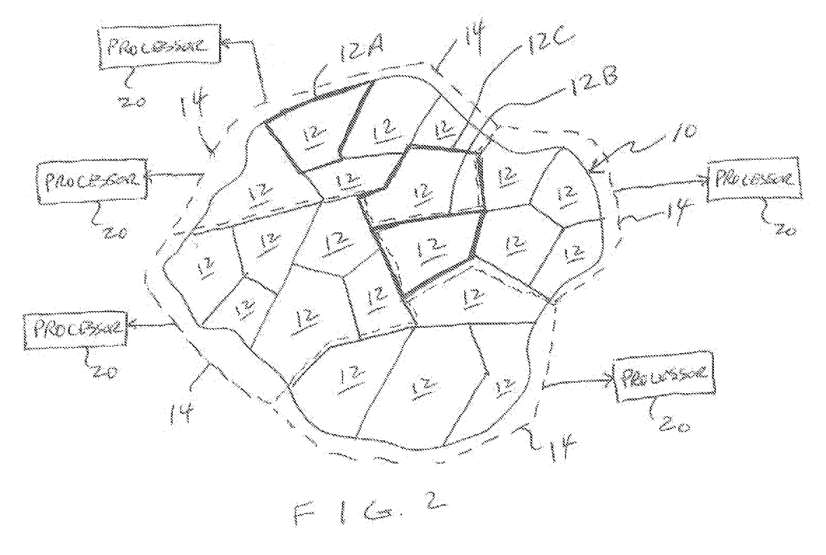

The first general step in parallel decoupled mesh generation is to divide bounded domain 10 into constituent elements or sub-domains 12 as shown in FIG. 2. Each of sub-domains 12 is a bounded portion of domain 10 where the closed boundaries thereof can include either (i) a portion of the natural periphery of domain 10 and generated internal interfaces (e.g., the sub-domain referenced by bold boundary lines 12A), or (ii) only generated internal interfaces (e.g., the sub-domain referenced by bold lines 12B). The areas (or volumes in the case of a three-dimensional bounded domain) defined by sub-domains 12 can be approximately the same or can be different without departing from the scope of the present invention although the detailed example that follows later herein generates sub-domains that are approximately equal in area.

The next step in the parallel decoupled mesh generation process is to assign sub-domains 12 to processors 20 where each processor is capable of independent and parallel operation. Each processor 20 is assigned to handle a particular group of sub-domains 12 where the groups are identified in FIG. 2 by dashed-line regions 14. Each processor 20 operates to first refine or discretize the closed boundary of each sub-domain 12 assigned thereto as will now be explained with the aid of FIG. 3. For simplicity of description and clarity of illustration, the points 16 of refinement or discretization are only shown for one of sub-domains 12. Each point 16 can be represented by a unique coordinate (e.g., an (x,y) coordinate in a two-dimensional problem or an (x,y,z) coordinate in a three-dimensional problem).

In the present invention, points 16 are generated based on the criteria or conditions that would optimize a particular mesh generation technique (e.g., angle size between separators/interfaces, local feature sizes, etc.) while decoupling two adjoining sub-domains where adjoining means the sharing of a boundary portion. Optimization of a mesh generation technique means that the mesh operation will proceed to termination without the introduction of vertices on a bounded region being meshed. Decoupling is achieved in the present invention when the optimized coordinates for points 16 on a shared boundary portion are the same. For example, in the present invention, corresponding ones of processors 20 assigned to handle sub-domains 12B and 12C independently generate identical coordinates for the “circled” ones of points 16.

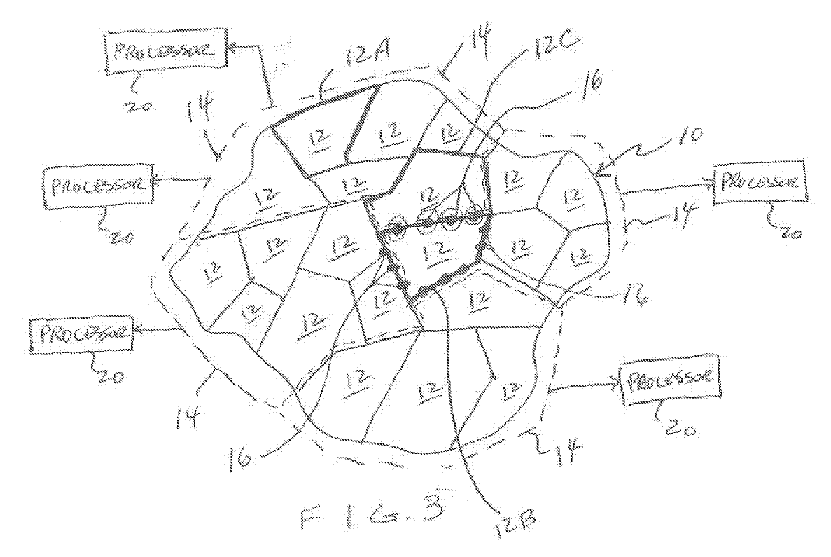

The next step in the parallel decoupled mesh generation process is for each processor 20 to independently run the mesh generation technique used to establish the criteria for defining points 16. This process is illustrated in progress in FIG. 4 where mesh generation for each region 14 proceeds independently and in parallel (for each sub-domain 12 therein) using the selected mesh generation technique and the coordinates of discretized points 16 associated with each region's sub-domains. A great advantage of the present invention is that an “off-the-shelf” mesh generation technique (e.g., a sequential mesh generation technique is typical) can be used “as is”. When each processor 20 has completed its independent and parallel mesh generation for its sub-domains 12, a collective mesh can be formed simply by assembling the meshed sub-domains 12 into a fully-meshed bounded domain 10 using the coordinates of points 16. This process requires no communication between processors or synchronization between processors, thereby yielding a completely decoupled methodology.

As mentioned above, the present invention can be implemented using a variety of methods of (i) domain decomposition (i.e., the dividing of a bounded domain into sub-domains), and (ii) sub-domain boundary discretizations depending on the type of bounded domain and selected mesh generation technique that is to be used. By way of a more detailed example, the process of the present invention will now be described for a two-dimensional bounded region that is divided into sub-domains using a novel “medial axis domain decomposition” (MADD) method with the groups of sub-domains being meshed independently and in parallel using the well-known Delaunay triangulated mesh generation technique. No communication between processors or synchronization between processors is required thereby yielding a completely decoupled methodology.

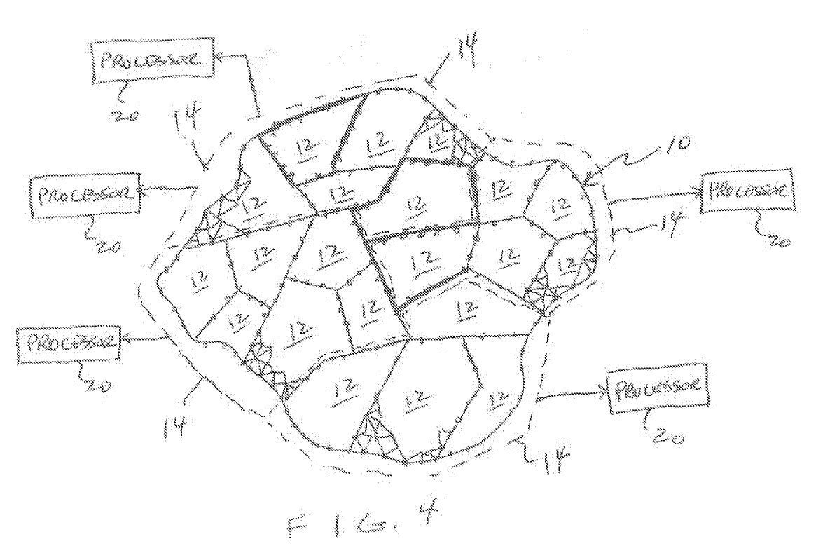

It is to be understood at the outset that the novel MADD method described herein is independent from the decoupled discretizing procedure so that it can be used in other parallel mesh generation methods that require good quality domain decompositions. The MADD method is based on an approximation of the medial axis (MA) of the domain. The MA is a known structure that can be used as a way to depict the shape of an object. As is well-known in the art, the medial axis of a bounded region is defined as the locus of the centers of all the maximal inscribed circles of the bounded region. For example, the medial axis of a simple bounded domain such as a rectangle illustrated in FIG. 5 is referenced by the bold lines 30. Note that the medial axis changes substantially when the bounded region is even slightly disturbed as illustrated in FIG. 6 where the medial axis referenced by bold lines 32 is changed relative to medial axis 30 by the simple convex disturbance.

In the remaining description, a bounded domain Ω is defined as the closure of an open connected bounded set, and the boundary ∂Ω is defined by a planar straight line graph which forms a set of (non-intersecting) line segments connecting pairs of points. A circle C in Ω is said to be maximal in Ω, if there is no other circle C′ in Ω such that C is a proper subset of C′. The closure of the locus of the circumcenters of all maximal circles in Ω is called the medial axis of Ω and will be denoted by MA(Ω). The intersection of a boundary of Ω and a maximal circle C is not empty. The points C ∩ ∂Ω, where a maximal circle C intersect the boundary, are called contact points of c, where c is the center of C. Every point c ε MA(Ω)\∂Ω has at least two contact points.

The MADD method is based on the following simple geometric property:

Let b be a contact point of c ε MA(Ω). The angles formed by the segment cb and the tangent of the boundary ∂Ω at b are at least π/2.

As is known in the art, the medial axis of Ω can be approximated by Voronoi points of a discretization of a domain. Using the above-described geometric property, separators in the domain are constructed that consist of linear segments that connect the Voronoi points to the external or peripheral boundary of the bounded domain. The approximation of the MA(Ω) is achieved in two steps:
(1) discretization of the peripheral boundary, and
(2) computation of a boundary-conforming Delaunay triangulation using the points from step (1).

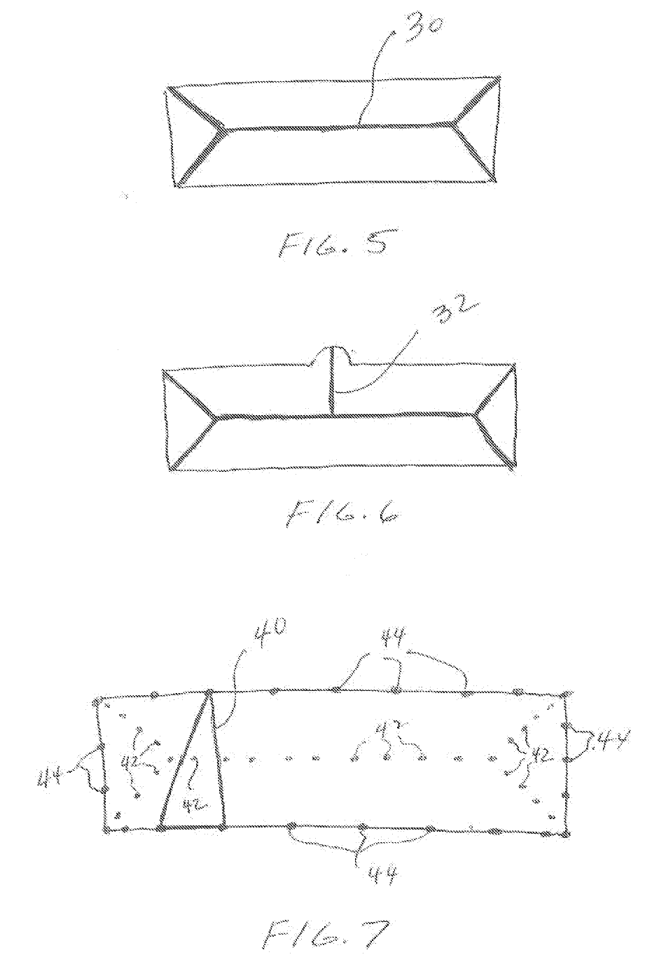

The circumcenters of the Delaunay triangles are the Voronoi points of the boundary vertices. For example, FIG. 7 illustrates a rectangular bounded domain and a single boundary-conforming Delaunay triangle 40 having a circumcenter 42. Triangle 40 is generated using discretized points 44 of the peripheral boundary of the bounded domain. The collection of such boundary-conforming triangles (not shown for clarity of illustration) yields a corresponding collection of circumcenters 42 that define the approximation of the medial axis in the MADD method. The level of the discretization of the peripheral boundary determines the quality of the approximation of the medial axis.

The goal of MADD is to generate sub-domains defined by angles that provide for good mesh generation later in the process. This goal is achieved by defining a set of triangles that will be used to generate separators of the bounded domain where the closed boundary of each sub-domain is defined by portions of the separators. The set of triangles is generated based on the following definition:

Let [symbol] be a Delaunay triangulation of a discretization D of the domain's peripheral boundary ∂Ω. A triangle t ε [symbol] is a junction triangle if:
1. it includes its circumcenter c,
2. at least two of its edges are not in D,
3. at least two of the segments defined by the circumcenter and the vertices of t form angles greater than or equal to a given threshold angle Φ₀, both with the domain's peripheral boundary and each other.

The first criteria is provided to simplify MADD in that it avoids negative weights and guarantees that at least two angles between the segments are good. The second criteria prevents a decomposition that will create very small sub-domains. The third criteria guarantees the quality of the angles as will now be briefly described. If a₁a₂a₃ are the vertices of t, the third criteria demands the existence of at least one pair of segments aᵢcaⱼ, where c is the circumcenter of a₁a₂a₃, so that all the angles formed with these segments are greater or equal to Φ₀. Such pairs are called partial separators and they will be the candidates used to form a complete separator. A complete separator decomposes a bounded domain into two connected sub-domains.

The MADD methodology starts with the approximation of the medial axis by the Delaunay triangulation [symbol] , and then uses selected ones of the medial axis approximations (i.e., selected ones of the circumcenters of the boundary-conforming Delaunay triangles) to create sub-domains. The key steps are as follows:
Step 1: Create a graph G [symbol] from the Delaunay triangulation [symbol] .
Step 2: Contract G [symbol] into the graph G′ [symbol] so that only the partial separators in “junction triangles” are represented as edges of G′ [symbol] .
Step 3: Partition the graph G′ [symbol] , optimizing the cut-cost to subgraph weight ratio.
Step 4: Translate the cuts of the previous partition into partial separators.
   These steps will now be explained in greater detail below.

Step 1: In this step, the Delaunay triangulation [symbol] of the peripheral boundary is represented as a weighted graph. Two nodes of the graph are adjacent if their corresponding edges belong in the same triangle. The length of the radius of the circumcircle of this triangle will be the weight of the graph edge.

Step 2: In this step, the graph G [symbol] produced from the previous step is contracted into a new graph G′ [symbol] , so that only the edges of “junction triangles” (defined below) are represented as nodes in G′ [symbol] . The nodes of G [symbol] that correspond to edges of non-junction triangles of [symbol] are contracted in G′ [symbol] . In order to contract the graph G′ [symbol] , it is necessary to iterate through all the triangles that are not junction triangles. The nodes of G [symbol] that correspond to the three edges of a non-junction triangle are combined into a single node and the new node replaces the initial nodes in the external graph edges, while the edges between the three initial nodes are deleted. The weight of the new node is the sum of the weights of the initial ones, plus the area of the triangle.

The remaining nodes correspond to the edges of what are defined herein as “junction triangles”. Junction triangles contain candidate partial separators, whose number may vary from one to three. From the three possible partial separators, the one that forms the greater minimum angle (between the partial separators) is retained. Since there is at least one partial separator in a junction triangle that forms angles no less than Φ₀, the selected partial separator forms angles greater than or equal to Φ₀. This partial separator is established by combining the two of the three nodes that correspond to edges of the triangle. Briefly, this part of MADD can be explained as follows. Let a₁a₂a₅ be a junction triangle and c₁ its circumcenter. Let dᵢⱼ be the corresponding node to the edge aᵢaⱼ, then the weight of the node dᵢⱼ is updated by adding the weight of the area included by the triangle c₁aᵢaⱼ. Let aⱼc_{1 ak} be the partial separator that forms the greater minimum angle. The nodes dⱼᵢ and dₖᵢ are contracted into a single node where aᵢ is the remaining vertex. The procedure is illustrated with the following example.

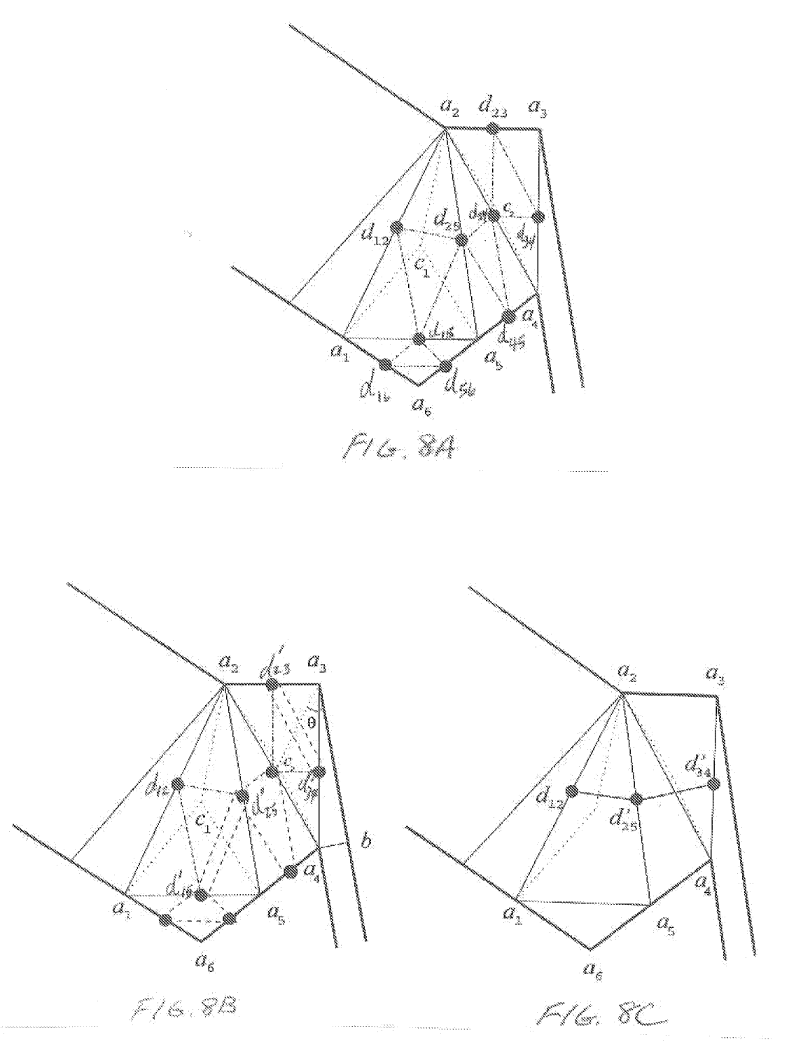

Referring now to FIGS. 8A-8C, the “Step 2” graph contraction will be explained. For each of these figures, the bold lines indicate the domain's external or peripheral boundary. The triangles are part of the boundary-conforming Delaunay triangulation of the domain. As described above, let dᵢⱼ denote the graph node that corresponds to the segment aᵢaⱼ. These “pre-graph contraction” nodes are shown in FIG. 8A. Four different cases are used to demonstrate junction versus non-junction triangles.

Case I: Referring now to FIG. 8B, the triangle a₁a₅a₆ has two edges on the boundary, so it is not a junction triangle. Therefore, the triangle's three corresponding nodes (i.e., d₁₅, d₁₆ and d₅₆) are combined to one designated d′₁₅. The edges connecting the new node d′₁₅ are the external ones, i.e., the edges that connect d₁₅ to d₁₂ and d₁₅ to d₂₅. The weight of the node is equal to the area of the triangle a₁a₅a₆.

Case II: The triangle a₂a₄a₅ does not include its circumcenter and so it is not a junction triangle. Following the same procedure as in Case I, the nodes d₂₅, d₂₄ and d₄₅ are contracted into a new node d′₂₅. The new node has a weight equal to the area of the triangle a₂a₄a₅ and is connected to the nodes d₁₂, d′₁₅, d₂₃ and d₃₄.

Case III: The triangle a₁a₂a₅ is a junction triangle. The areas of the triangles formed by its circumcenter c₁ and its corners are added to the weight of the corresponding nodes. For example, the area |a₂c₁a₁| is added to the node d₁₂. Similarly, the areas |a2 a₅c₁| and |a₁c₁a₅| are added to the nodes d′₂₅ and d′₁₅, respectively. Suppose that the partial separator a₁c₁a₂ is the one that that forms the greater minimum angle. In this case, the nodes d′₁₅ and d′₂₅ are contracted into a new node d′₂₅ with its weight equaling the sum weights of the two previous nodes. The graph edge connecting the nodes d′₁₅ and d′₂₅ is deleted, while the two other graph edges are contracted into one edge connecting d′₂₅ to d₁₂. The new edged weight is equal to the sum of the two previous edge weights, which is equal to the length of the partial separator a₁c₁a₂.

Case IV: Referring additionally to FIG. 8C, the triangle a₂a₃a₄ is also a junction triangle. Similar to Case III, the areas of the triangles formed by the circumcenter c₂ and the vertices are added. The areas |a₂c₂a₄|, |a₂c₂a₃| and |a₃c₂a₄| are added to the weight of the nodes d′₂₅, d′₂₃ and d′₃₄, respectively.

Step 3: After contracting the graph, the constructed graph G′ [symbol] is partitioned. The number of the edges of the graph is less than or equal to the number of junction triangles. Thus, the size of the graph partitioning problem is significantly smaller than the element-wise dual graph of the boundary-conforming Delaunay triangulation [symbol] . Graph partitioning is well known in the art. Any method that partitions the graph into two connected subgraphs with good cut cost to subgraph weight ratio can be used as the graph partitioner for G′ [symbol] without departing from the scope of the present invention.

Step 4: After partitioning G′ [symbol] , the final step of MADD is to construct the separator of the geometry. From the previous step, the graph G′ [symbol] is partitioned into two connected subgraphs. This partition will give a corresponding separator for the geometry. Each edge of the graph corresponds to a partial separator of the form aᵢcaⱼ, where c is a circumcenter of a junction triangle and aᵢ, aⱼ are two of its vertices. For every graph edge that is cut by the partition, the related partial separator is inserted in the geometry.

The above-described stepwise process continues for all triangles and identifies those triangles whose edges correspond to disconnected nodes after graph partitioning. For such identified triangles, partial separators are inserted to separate the edges that do not belong to the same subgraph. As a result of this process, 2-way decomposition is achieved. In practice, MADD can be applied in a “divide and conquer” way to completely divide the given bounded domain into its constituent sub-domains.

The separators and the sub-domains created by the MADD procedure have good quality in terms of the shape and size. However, since the goal is to be able to create Delaunay meshes independently for each sub-domain, the final mesh must be Delaunay conforming. In order to ensure the Delaunay conformity in the mesh generation context, the separators must be refined or discretized using conditions derived from the mesh refining algorithm. An abstraction used to describe/prove this (referred to herein as a “decoupling path”) guarantees that the mesh generation procedure can be applied independently on each sub-domain, thereby assuring a Delaunay conforming mesh for the whole bounded domain that is formed by the union of all the sub-meshes. This abstraction is achieved by refining or discretizing a sub-domain's boundary such that the distance between adjacent discretized points is specified as described below.

In general and as described above, the boundaries of the sub-domains are discretized to satisfy the conditions of the mesh generation technique. In this example, the sequential Delaunay triangulated mesh generation technique using Ruppert's algorithm is applied. The length or distance between two adjacent discretized points of a sub-domain's boundary is based on a real constant parameter k. Briefly, let L=min{|s|} where s is a segment of a separator making up part of a sub-domain's boundary. Here, k must satisfy the relationship
0<k<min(lfsₘᵢₙ(D_{H}), L/4)
where lfsₘᵢₙ represents the minimum local feature size of the sub-domain and D_{H} represents the union of the peripheral boundary of the original domain and the set of separators generated by MADD. The parameter k will be calculated from the conditions of the mesh generation technique, so that it can be guaranteed that no edge will be created with length less than k. For example, when Ruppert's algorithm is applied using the quality criteria for the circumradius to shortest edge ratio, k is defined as k=min{lfsₘᵢₙ(D_{H}), L/4}. Other criteria of Ruppert's algorithm could also be used when defining k without departing from the scope of the present invention.

In summary, for this example, the procedure of discretizing the separators created by MADD creates a decoupling path with respect to Ruppert's algorithm. This permits the generation of Delaunay meshes independently for each sub-domain with good quality and of desired size. The final mesh (i.e., formed by the union of the submeshes using the coordinates generated during the discretizing process) is Delaunay conforming. As a result, this procedure decouples the domain to provide completely independent parallelization of the mesh generation procedure that eliminates communication and synchronization between the processors.

Although the invention has been described relative to a specific embodiment thereof, there are numerous variations and modifications that will be readily apparent to those skilled in the art in light of the above teachings. For example, while the described MADD method of domain decomposition is based on an approximation of a domain's medial axis, the present invention could also utilize domain decomposition methodologies that were based on the exact medial axis of a bounded domain. It is therefore to be understood that, within the scope of the appended claims, the invention may be practiced other than as specifically described.

What is claimed as new and desired to be secured by Letters Patent of the United States is:

1. A method of mesh generation processing, comprising the steps of:
providing a bounded domain;
dividing said bounded domain into constituent sub-domains with each of said sub-domains being defined by a closed boundary;
providing a plurality of processors;
assigning a portion of said sub-domains to each of said processors; and
operating each of said processors independently and in parallel, each of said processors
(i) discretizing said closed boundary for each of said sub-domains assigned thereto to generate coordinates that discretely define each said closed boundary wherein said coordinates are identical for each portion of one said closed boundary that adjoins a portion of another one said closed boundary, and wherein all of said coordinates satisfy specific conditions that optimize a selected mesh generation technique, and
(ii) generating a mesh for each of said sub-domains assigned thereto using corresponding ones of said coordinates and said selected mesh generation technique.

2. A method according to claim 1 wherein said step of dividing is carried out such that each of said sub-domains is approximately equal in area when said bounded domain is two-dimensional.

3. A method according to claim 1 wherein said selected mesh generation technique is a sequential mesh generation technique.

4. A method according to claim 1 wherein said step of dividing is based on a structure capable of being used to depict the shape of said bounded domain.

5. A method according to claim 4 wherein said structure is selected from the group consisting of an approximation of a medial axis of said bounded domain and an exact medial axis of said bounded domain.

6. A method according to claim 1 wherein said selected mesh generation technique is a Delaunay triangulated mesh generation technique.

7. A method according to claim 1 further comprising the step of forming a collective mesh for said bounded domain using each said mesh so-generated for said sub-domains and said coordinates corresponding thereto.

8. A method of mesh generation processing, comprising the steps of:
providing a bounded domain;
dividing said bounded domain into constituent sub-domains using one of a medial axis of said bounded domain and an approximation of a medial axis of said bounded domain, wherein each of said sub-domains is defined by a closed boundary;
providing a plurality of processors;
assigning a portion of said sub-domains to each of said processors; and
operating each of said processors independently and in parallel, each of said processors
(i) discretizing said closed boundary for each of said sub-domains assigned thereto to generate coordinates that discretely define each said closed boundary wherein said coordinates are identical for each portion of one said closed boundary that adjoins a portion of another one said closed boundary, and wherein all of said coordinates satisfy specific conditions that optimize a sequential mesh generation technique, and
(ii) generating a mesh for each of said sub-domains assigned thereto using corresponding ones of said coordinates and said sequential mesh generation technique.

9. A method according to claim 8 wherein said step of dividing is carried out such that each of said sub-domains is approximately equal in area when said bounded domain is two-dimensional.

10. A method according to claim 8 wherein said sequential mesh generation technique is a Delaunay triangulated mesh generation technique.

11. A method according to claim 8 further comprising the step of forming a collective mesh for said bounded domain using each said mesh so-generated for said sub-domains and said coordinates corresponding thereto.

12. A method of mesh generation processing, comprising the steps of:
providing a two-dimensional bounded domain defined by a peripheral boundary;
generating boundary-conforming Delaunay triangles using points on said peripheral boundary, wherein an approximation of a medial axis of said bounded domain is defined by circumcenters of said boundary-conforming Delaunay triangles;
dividing said bounded domain into constituent sub-domains using selected ones of said circumcenters, wherein each of said sub-domains is defined by a closed boundary;
providing a plurality of processors;
assigning a portion of said sub-domains to each of said processors; and
operating each of said processors independently and in parallel, each of said processors
(i) discretizing said closed boundary for each of said sub-domains assigned thereto to generate coordinates that discretely define each said closed boundary wherein said coordinates are identical for each portion of one said closed boundary that adjoins a portion of another one said closed boundary, and wherein all of said coordinates satisfy specific conditions that optimize a sequential mesh generation technique, and
(ii) generating a mesh for each of said sub-domains assigned thereto using corresponding ones of said coordinates and said sequential mesh generation technique.

13. A method according to claim 12 wherein said step of dividing is carried out such that each of said sub-domains is approximately equal in area when said bounded domain is two-dimensional.

14. A method according to claim 12 wherein said sequential mesh generation technique is a Delaunay triangulated mesh generation technique.

15. A method according to claim 12 further comprising the step of forming a collective mesh for said bounded domain using each said mesh so-generated for said sub-domains and said coordinates corresponding thereto.
